(19) United States
(12) Patent Application Publication
(10) Pub. No.: US 2026/0122157 A1
(43) Pub. Date: Apr. 30, 2026

(54) SYSTEM AND METHOD FOR TB PPDU TRANSMISSION

(71) Applicant: NXP USA, Inc., AUSTIN, TX (US)

(72) Inventors: Liwen Chu, San Ramon, CA (US); Rui Cao, Sunnyvale, CA (US); Hari Ram Balakrishnan, Chennai (IN); Hongyuan Zhang, Fremont, CA (US)

(21) Appl. No.: 19/369,844

(22) Filed: Oct. 27, 2025

(30) Foreign Application Priority Data
Oct. 25, 2024 (IN) 202441081516

(51) Int. Cl. H04L 69/323; H04L 47/2425

(52) U.S. Cl. CPC H04L 69/323; H04L 47/2433

(57) ABSTRACT

Embodiments of a method and apparatus for wireless communications are disclosed. In an embodiment, a wireless device includes a controller configured to generate a trigger-based (TB) physical layer protocol data unit (PPDU) in response to a trigger frame from a wireless access point (AP) and a wireless transceiver configured to transmit the TB PPDU to the wireless AP.

### CROSS-REFERENCE TO RELATED APPLICATIONS

This application is entitled to the benefit of Indian Provisional Patent Application No. 202441081516, filed on Oct. 25, 2024, the contents of which are incorporated by reference herein in their entireties.

### BACKGROUND

Wireless communications devices, e.g., access points (APs) or non-AP devices transmit various types of information using different transmission techniques. For example, various applications, such as, Internet of Things (IOT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to generate a trigger-based (TB) physical layer protocol data unit (PPDU) in response to a trigger frame from a wireless access point (AP) and a wireless transceiver configured to transmit the TB PPDU to the wireless AP. Other embodiments are also disclosed.

In an embodiment, the trigger frame is transmitted by the wireless AP to the wireless device and any wireless station (STA) associated with the wireless AP.

In an embodiment, the wireless device acts as a second wireless AP.

In an embodiment, the wireless AP includes a sharing AP that shares a wireless channel, and the second wireless AP includes a shared AP to which the wireless channel is shared.

In an embodiment, the wireless AP transmits the trigger frame with a padding for the second wireless AP under an assumption that the second AP's padding requirement is 16 micro seconds.

In an embodiment, the wireless transceiver is further configured to notify a padding requirement for preparing the TB PPDU to the wireless AP.

In an embodiment, the wireless AP transmits the trigger frame with a padding for the second wireless AP based on the padding requirement acquired from the wireless device.

In an embodiment, the controller is further configured to set a Basic Service Set (BSS) Color in a physical layer (PHY) header of the TB PPDU to a BSS color of the wireless AP.

In an embodiment, before the wireless transceiver transmits the TB PPDU to the wireless AP, the wireless AP requests the wireless device to perform a clear channel assessment (CCA).

In an embodiment, the second wireless AP has one NAV a Network Allocation Vector (NAV) timer, and does not transmit the TB PPDU if the second wireless AP's NAV timer has a non-zero value.

In an embodiment, the second wireless AP has an intra-Basic Service Set (BSS) Network Allocation Vector (NAV) timer and a basic NAV timer, and does not transmit the TB PPDU if either of the intra-BSS NAV timer and the basic NAV timer has a non-zero value.

In an embodiment, a method for wireless communications includes at a wireless device, generating a trigger-based (TB) physical layer protocol data unit (PPDU) in response to a trigger frame from a wireless access point (AP) and from the wireless device, transmitting the TB PPDU to the wireless AP.

In an embodiment, the trigger frame is transmitted by the wireless AP to the wireless device and any wireless station (STA) associated with the wireless AP.

In an embodiment, the wireless device acts as a second wireless AP.

In an embodiment, the wireless AP includes a sharing AP that shares a wireless channel, and the second wireless AP includes a shared AP to which the wireless channel is shared.

In an embodiment, the wireless AP transmits the trigger frame with a padding for the second wireless AP under an assumption that the second AP's padding requirement is 16 micro seconds.

In an embodiment, the method further includes from the wireless device, notifying a padding requirement for preparing the TB PPDU to the wireless AP.

In an embodiment, the wireless AP transmits the trigger frame with a padding for the second wireless AP based on the padding requirement acquired from the wireless device.

In an embodiment, at the wireless device, generating the TB PPDU includes at the wireless device, setting a Basic Service Set (BSS) Color in a physical layer (PHY) header of the TB PPDU to a BSS color of the wireless AP.

In an embodiment, before the TB PPDU is transmitted to the wireless AP, the wireless AP requests the wireless device to perform a clear channel assessment (CCA).

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with an embodiment of the disclosure.

FIG. 2 depicts a multi-link (ML) communications system that is used for wireless communications in accordance with an embodiment of the disclosure.

FIG. 3 depicts a wireless device in accordance with an embodiment of the disclosure.

FIG. 4 illustrates some communications between a sharing AP, a shared AP, and two stations (STAs) in accordance with example embodiments.

FIG. 5 illustrates a TB PPDU format in accordance with an embodiment of the disclosure.

FIG. 6 is a process flow diagram of a method for wireless communications in accordance with an embodiment of the disclosure.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

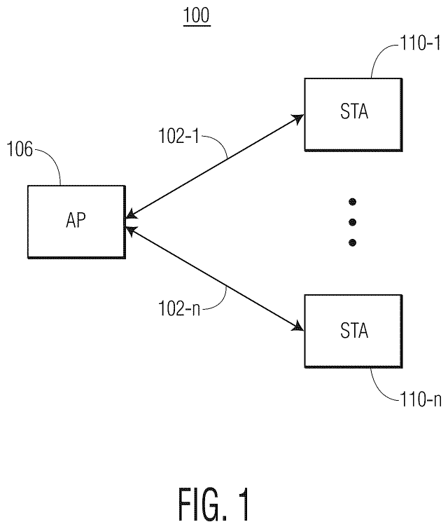

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

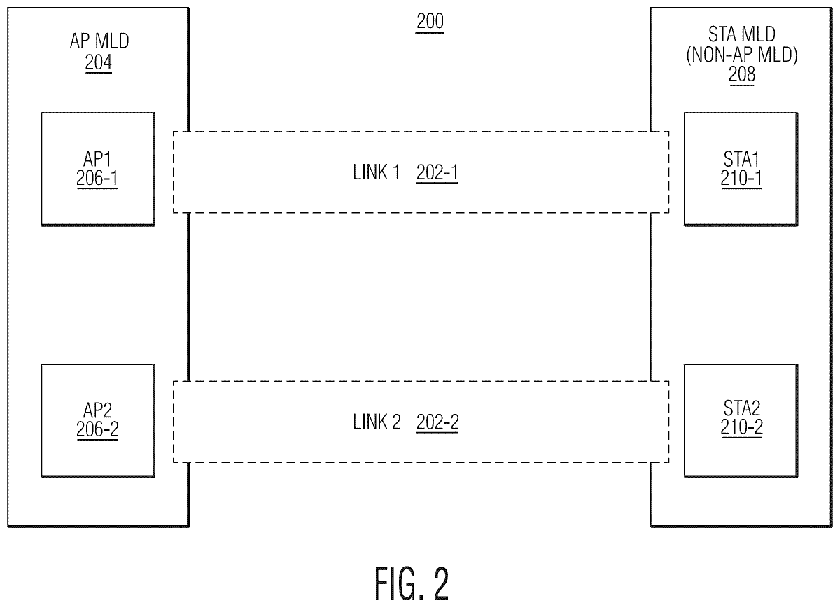

FIG. 2 depicts a multi-link (ML) communications system 200 that is used for wireless (e.g., WiFi) communications in accordance with an embodiment of the disclosure. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

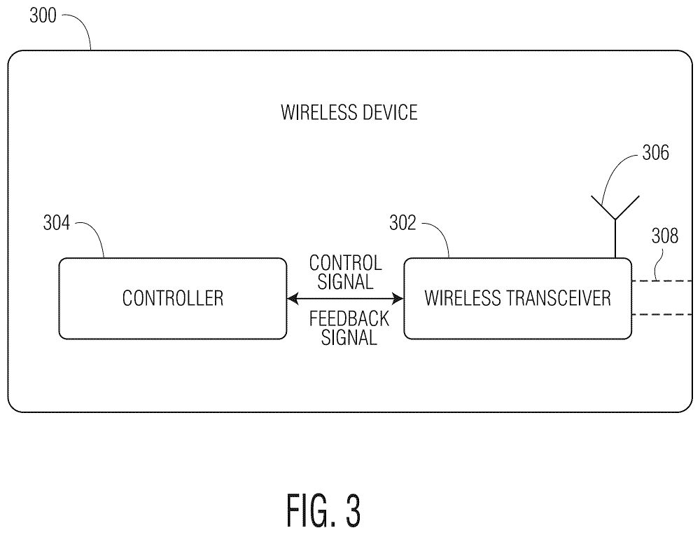

FIG. 3 depicts a wireless device 300 in accordance with an embodiment of the disclosure. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

In accordance with an embodiment of the disclosure, the controller 304 is configured to generate a trigger-based (TB) physical layer protocol data unit (PPDU) in response to a trigger frame from a wireless access point (AP), and the wireless transceiver 302 is configured to transmit the TB PPDU to the wireless AP, for example, through the at least one antenna 306.

In some embodiments, the trigger frame is transmitted by the wireless AP to the wireless device 300 and any wireless station (STA) associated with the wireless AP. In some embodiments, the wireless device 300 acts as a client STA associated with the wireless AP. In some embodiments, the wireless AP treats the wireless device 300 as an associated STA when using the trigger frame to solicit the TB PPDU from the wireless device 300 and the any wireless station STA associated with the wireless AP.

In some embodiments, the wireless device 300 includes or acts as a second wireless AP. In some embodiments, the wireless AP includes a sharing AP that shares a wireless channel, and the second wireless AP includes a shared AP to which the wireless channel is shared.

In some embodiments, the wireless AP transmits the trigger frame with a padding for the second wireless AP under an assumption that the second AP's padding requirement is 16 micro seconds.

In some embodiments, the wireless transceiver 302 is further configured to notify a padding requirement for preparing the TB PPDU to the wireless AP.

In some embodiments, the wireless AP transmits the trigger frame with a padding for the second wireless AP based on the padding requirement acquired from the wireless device 300.

In some embodiments, the wireless transceiver 302 is further configured to receive a padding requirement of preparing the TB PPDU from the wireless AP as the shared AP, for example, through the at least one antenna 306, and the controller 304 is further configured to generate the TB PPDU according to the padding requirement of the sharing AP.

In some embodiments, the controller 304 is further configured to set a Basic Service Set (BSS) Color in a physical layer (PHY) header of the TB PPDU transmitted by the shared AP to a BSS color of the wireless AP as the sharing AP.

In some embodiments, before the wireless transceiver 302 transmits the TB PPDU to the wireless AP as the sharing AP, the wireless AP as the sharing AP requests the wireless device 300 to perform a clear channel assessment (CCA) before transmitting the TB PPDU.

In some embodiments, the second wireless AP has a Network Allocation Vector (NAV) timer, and does not transmit the TB PPDU if the second wireless AP's NAV timer has a non-zero value.

In some embodiments, the second wireless AP has an intra-Basic Service Set (BSS) Network Allocation Vector (NAV) timer and a basic NAV timer, and does not transmit the TB PPDU if either of the intra-BSS NAV timer and the basic NAV timer has a non-zero value.

In some embodiments, the wireless device 300 is compatible with an Institute of Electrical and Electronics Engineers (IEEE) 802.11 protocol.

In some embodiments, the wireless device 300 includes an AP affiliated with a wireless multi-link device (MLD), and the wireless transceiver 302 is further configured to conduct frame exchanges (for example, taking part in the operation or management of frame exchanges, such as to transmit and receive frames) with another AP affiliated with second wireless MLD through wireless links between the wireless MLD and the second wireless MLD.

IEEE 802.11ax standard defines setting rules of the PHY header of a trigger-based (TB) physical layer protocol data unit (PPDU) TB PPDU and CCA rules before transmitting a TB PPDU when the TB PPDU transmitter is an associated STA of the AP transmitting the soliciting trigger frame. IEEE 802.11bn standard introduces multi-AP coordination operation (Coordinated Time Division Multiple Access (C-TDMA), Coordinated beamforming (CBF)) where a sharing AP may solicit a TB PPDU from shared APs.

In some implementations, intra-BSS Network Allocation Vector (NAV) timer and basic NAV timer are treated differently when the soliciting trigger frame has carrier sensing (CS) Required equal to 1. The BSS color setting in the PHY header of a TB PPDU needs to be addressed since multiple APs (e.g., a sharing AP and shared APs) have the different BSS color. The AP and the STA have the different rules to set the Transmit opportunity (TXOP) in the PHY header when BSS color is disabled. In some implementations, a sharing AP may solicit a TB PPDU from a shared AP during the Coordinated Beamforming (Co-BF)/Coordinated Spatial Reuse (Co-SR) preparing stage if the shared AP supports the TB PPDU transmission. In some implementations, a sharing AP may notify the TXOP time allocation to the shared AP by soliciting a TB PPDU from the shared AP.

In some embodiments, a sharing AP treats a shared AP as an associated STA when using a trigger frame solicits a trigger-based (TB) physical layer protocol data unit (PPDU) from the shared AP.

In some embodiments, a shared AP acts as associated STA and treats the sharing AP as an associated AP when transmitting a TB PPDU in response to the soliciting trigger frame.

In some embodiments, a sharing AP (pAP) or primary/Initiator AP corresponds to an AP which shares its medium time of a TXOP and a shared AP (sAP) or secondary AP corresponds to an AP to which the medium time is shared.

Some implementations of BSS Color in the PHY Header of an AP's TB PPDU, for example, by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, a shared AP being solicited by a sharing AP's trigger frame sets the BSS Color in the PHY header of a TB PPDU to the sharing AP's BSS color. With this, the sharing AP's associated STA(s) set(s) the same BSS color in the TB PPDU as the shared AP.

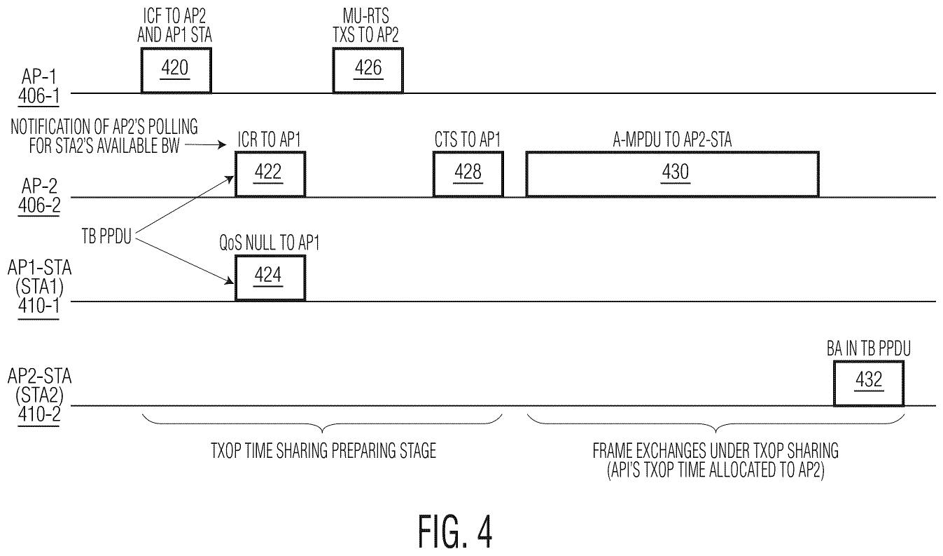

FIG. 4 illustrates some communications between a sharing AP 406-1, a shared AP 406-2, and two stations (STAs) 410-1, 410-2 in accordance with example embodiments. In some embodiments, the sharing AP 406-1, which is also referred to as AP1, shares at least some medium time of its TXOP to the shared AP and the shared AP 406-2, which is also referred to as AP2, is an AP to which the medium time is shared. In some embodiments, the STA 410-1, which is also referred to as STA1, associates with the sharing AP 406-1 and the STA 410-2, which is also referred to as STA2, associates with the shared AP 406-2. The sharing AP 406-1 and/or the shared AP 406-2 depicted in FIG. 4 may be the same as or similar to an embodiment of the AP 106 depicted in FIG. 1, the APs 206-1, 206-2 depicted in FIG. 2, and/or the wireless device 300 depicted in FIG. 3. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, and/or the wireless device 300 depicted in FIG. 3.

As illustrated in FIG. 4, in a time sequence during a TXOP time sharing preparing stage, the sharing AP (AP1) 406-1 transmits an Initial Control Frame (ICF) 420 to the shared AP (AP2) 406-2 to notify that the sharing AP would like to share its medium time in the TXOP to the shared AP and the STA (STA1) 410-1. The shared AP (AP2) 406-2 transmits a TB PPDU 422 that carries an initial control response (ICR) to the sharing AP (AP1) 406-1. In some embodiments, the ICF carries a notification of the shared AP (AP2) 406-2 about whether the share AP (AP2) 406-2 would like to accept the allocation. The STA (STA1) 410-1 transmits a TB PPDU 424 that carries a Quality of Service (QOS) Null frame to the sharing AP (AP1) 406-1 to report its buffer status. In some embodiments, the shared AP (AP2) 406-2 being solicited by the sharing AP (AP1) 406-1's trigger frame sets the BSS Color in the PHY header of the TB PPDU 422 to the sharing AP (AP1) 406-1's BSS color. With this, the sharing AP (AP1) 406-1's associated STA (STA1) 410-1 sets the same BSS color in the TB PPDU 424 as the shared AP (AP2) 406-2. Subsequently, the sharing AP (AP1) 406-1 transmits a Multi-user (MU)-request to send (RTS) TXS (TXOP sharing) message 426 to the shared AP (AP2) 406-2 and the shared AP (AP2) 406-2 transmits a clear to send (CTS) message 428 to the sharing AP (AP1) 406-1.

Subsequently, as illustrated in FIG. 4, in a time sequence during frame exchanges under TXOP sharing (API's TXOP time allocated to AP2), the shared AP (AP2) 406-2 transmits one or multiple Aggregated MAC Protocol Data Units (A-MPDUs) 430 to the STA (STA2) 410-2 and the STA (STA2) 410-2 transmits a SU (Single User) or TB PPDU that carries a block acknowledgement (BA) for each A-MPDU soliciting the BA to the shared AP (AP2) 406-2.

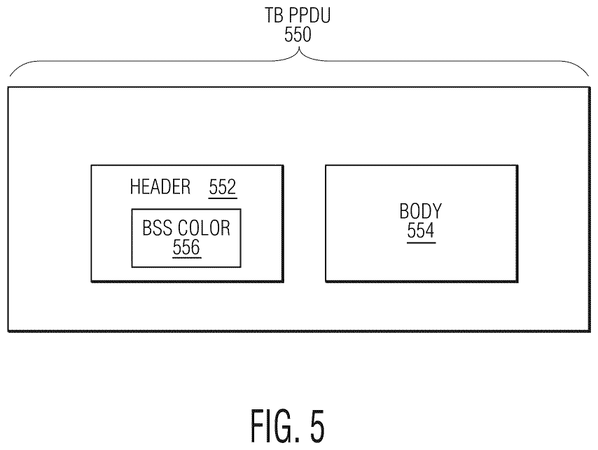

FIG. 5 illustrates a TB PPDU format 550 in accordance with an embodiment of the disclosure. The TB PPDU format 550 illustrated in FIG. 5 can be used for communications by the wireless communications system 100 depicted in FIG. 1, by a STA/AP affiliated with the multi-link (ML) communications system 200 depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4. In the embodiment depicted in FIG. 5, the TB PPDU format 550 includes a header (e.g., a PPDU PHY header) 552 and a body (e.g., a Data field of the PPDU that carries the physical layer Service Data Unit (PSDU)) 554. In some embodiments, the header 552 is a PHY header that includes a BSS color of a sharing AP (e.g., the sharing AP (AP1) 406-1) being filled by the shared AP 406-2.

Some implementations of clear channel assessment (CCA) for an AP's TB PPDU transmission, for example, by the wireless communications system 100 depicted in FIG. 1, the STA/AP of multi-link (ML) device in a link of the multi-link communications system 200 depicted in FIG. 2, the wireless device 300 depicted in FIG. 3, and/or the sharing AP (AP1) 406-1 and/or the shared AP (AP2) 406-2 depicted in FIG. 4 are described.

In an observation, a shared AP implements an intra-BSS NAV timer and a basic NAV timer, and the shared AP's intra-BSS NAV timer cannot be ignored when a sharing AP requests the shared AP's CCA before sending a response frame in a TB PPDU.

In some embodiments, a shared AP with an intra-BSS NAV timer and a basic NAV timer cannot send a responding frame in a TB PPDU if the following conditions are both true:
the sharing AP requests the shared AP to perform the CCA before sending the TB PPDU; and
the shared AP figures out/detects that its intra-BSS NAV timer has a non-zero value, or the basic NAV timer has a non-zero value and the owner of the frame/PPDU used to set the basic NAV timer is not the sharing AP.

In some embodiments, the shared AP with a NAV timer cannot send a responding frame in a TB PPDU if the following conditions are both true:
the sharing AP requests the shared AP to perform the CCA before sending the TB PPDU; and
the shared AP figures out/detects that the NAV timer has a non-zero value and the owner of the frame/PPDU used to set the NAV timer is not the sharing AP.

Some implementations of padding (e.g., in trigger soliciting an AP's TB PPDU), for example, by the wireless communications system 100 depicted in FIG. 1, the STA/AP of multi-link (ML) device in a link of the multi-link communications system 200 depicted in FIG. 2, the wireless device 300 depicted in FIG. 3, and/or the sharing AP (AP1) 406-1 and/or the shared AP (AP2) 406-2 depicted in FIG. 4 are described.

In an observation, for padding requirement of a shared AP, the shared AP may need additional time for preparing a TB PPDU solicited by a sharing AP.

In some embodiments, in a first solution, a sharing AP assumes a shared AP needs 16 microseconds (μs) padding time or another fixed value of padding requirement.

In some embodiments, in a second solution, a shared AP notifies its padding requirement to a sharing AP when the shared AP negotiates a Coordinated Time Division Multiple Access (C-TDMA) agreement with the sharing AP.

In some embodiments, a method of conducting TB PPDU transmission from a first device(s) to a second device where the first device and second device are APs, the method comprising either of: transmitting, by the second device, a trigger frame to one or multiple first devices besides 0 or more than 0 STAs associated with the second device that announce the support of transmitting a TB PPDU; and transmitting, by the first device, the TB PPDU addressed to the second device. In some embodiments, the second device treats a first device as an associated STA when using a Trigger frame to solicit a TB PPDU from the first device and the other devices. In some embodiments, the first device acts as a client STA associated with the second device and treats the second device as its associated AP when transmitting a TB PPDU in response to the soliciting trigger frame from the second device. In some embodiments, the second device notifies its padding requirement of preparing the TB PPDU transmission.

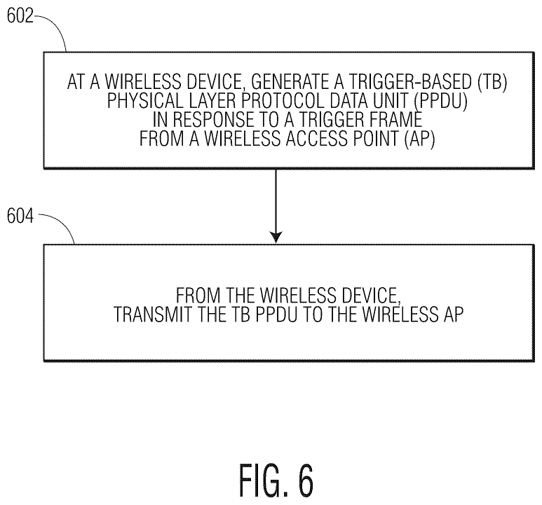

FIG. 6 is a process flow diagram of a method for wireless communications in accordance with an embodiment of the disclosure. At block 602, at a wireless device, a trigger-based (TB) physical layer protocol data unit (PPDU) is generated in response to a trigger frame from a wireless access point (AP). At block 604, from the wireless device, the TB PPDU is transmitted to the wireless AP. In some embodiments, the trigger frame is transmitted by the wireless AP to the wireless device and any wireless station (STA) associated with the wireless AP. In some embodiments, the wireless device acts as or includes a second wireless AP. In some embodiments, the wireless AP includes a sharing AP that shares a wireless channel or TXOP medium time, and the second wireless AP includes a shared AP to which the wireless channel or TXOP medium time is shared. In some embodiments, the wireless AP transmits the trigger frame with a padding for the second wireless AP under an assumption that the second AP's padding requirement is 16 micro seconds. In some embodiments, from the wireless device, a padding requirement for preparing the TB PPDU is notified to the wireless AP. In some embodiments, the wireless AP transmits the trigger frame with a padding for the second wireless AP based on the padding requirement acquired from the wireless device. In some embodiments, at the wireless device, a padding requirement of preparing the TB PPDU is received from the wireless AP, and at the wireless device, the TB PPDU is generated according to the padding requirement. In some embodiments, at the wireless device, a Basic Service Set (BSS) Color in a physical layer (PHY) header of the TB PPDU is set to a BSS color of the wireless AP. In some embodiments, before the TB PPDU is transmitted to the wireless AP, the wireless AP requests the wireless device to perform a clear channel assessment (CCA). In some embodiments, the second wireless AP has one NAV a Network Allocation Vector (NAV) timer, and does not transmit the TB PPDU if the second wireless AP's NAV timer has a non-zero value. In some embodiments, the second wireless AP has an intra-Basic Service Set (BSS) Network Allocation Vector (NAV) timer and a basic NAV timer, and does not transmit the TB PPDU if either of the intra-BSS NAV timer and the basic NAV timer has a non-zero value. In some embodiments, the wireless device is compatible with an Institute of Electrical and Electronics Engineers (IEEE) 802.11 protocol. In some embodiments, the wireless device includes an AP affiliated with a wireless AP multi-link device (MLD), and frame exchanges are conducted with an AP affiliated with second wireless AP MLD through wireless links between the wireless MLD and the second wireless MLD. The wireless device may be the same as or similar to an embodiment of the AP 106 depicted in FIG. 1, the APs 206-1, 206-2 depicted in FIG. 2, the wireless device 300 depicted in FIG. 3, and/or the shared AP (AP2) 406-2 depicted in FIG. 4. The wireless AP may be the same as or similar to an embodiment of the AP 106 depicted in FIG. 1, the APs 206-1, 206-2 depicted in FIG. 2, the wireless device 300 depicted in FIG. 3, and/or the sharing AP (AP1) 406-1 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate a trigger-based (TB) physical layer protocol data unit (PPDU) in response to a trigger frame from a wireless access point (AP); and
a wireless transceiver configured to transmit the TB PPDU to the wireless AP.

2. The wireless device of claim 1, wherein the trigger frame is transmitted by the wireless AP to the wireless device and any wireless station (STA) associated with the wireless AP.

3. The wireless device of claim 2, wherein the wireless device acts as a second wireless AP.

4. The wireless device of claim 3, wherein the wireless AP comprises a sharing AP that shares a wireless channel, and wherein the second wireless AP comprises a shared AP to which the wireless channel is shared.

5. The wireless device of claim 3, wherein the wireless AP transmits the trigger frame with a padding for the second wireless AP under an assumption that the second AP's padding requirement is 16 micro seconds.

6. The wireless device of claim 3, wherein the wireless transceiver is further configured to notify a padding requirement for preparing the TB PPDU to the wireless AP.

7. The wireless device of claim 6, wherein the wireless AP transmits the trigger frame with a padding for the second wireless AP based on the padding requirement acquired from the wireless device.

8. The wireless device of claim 1, wherein the controller is further configured to set a Basic Service Set (BSS) Color in a physical layer (PHY) header of the TB PPDU to a BSS color of the wireless AP.

9. The wireless device of claim 1, wherein before the wireless transceiver transmits the TB PPDU to the wireless AP, the wireless AP requests the wireless device to perform a clear channel assessment (CCA).

10. The wireless device of claim 3, wherein the second wireless AP has one Network Allocation Vector (NAV) timer, and does not transmit the TB PPDU if the second wireless AP's NAV timer has a non-zero value.

11. The wireless device of claim 3, wherein the second wireless AP has an intra-Basic Service Set (BSS) Network Allocation Vector (NAV) timer and a basic NAV timer, and does not transmit the TB PPDU if either of the intra-BSS NAV timer and the basic NAV timer has a non-zero value.

12. A method for wireless communications, the method comprising:
at a wireless device, generating a trigger-based (TB) physical layer protocol data unit (PPDU) in response to a trigger frame from a wireless access point (AP); and
from the wireless device, transmitting the TB PPDU to the wireless AP.

13. The method of claim 12, wherein the trigger frame is transmitted by the wireless AP to the wireless device and any wireless station (STA) associated with the wireless AP.

14. The method of claim 13, wherein the wireless device acts as a second wireless AP.

15. The method of claim 14, wherein the wireless AP comprises a sharing AP that shares a wireless channel, and wherein the second wireless AP comprises a shared AP to which the wireless channel is shared.

16. The method of claim 14, wherein the wireless AP transmits the trigger frame with a padding for the second wireless AP under an assumption that the second AP's padding requirement is 16 micro seconds.

17. The method of claim 16, further comprising from the wireless device, notifying a padding requirement for preparing the TB PPDU to the wireless AP.

18. The method of claim 17, wherein the wireless AP transmits the trigger frame with a padding for the second wireless AP based on the padding requirement acquired from the wireless device.

19. The method of claim 12, wherein at the wireless device, generating the TB PPDU comprises at the wireless device, setting a Basic Service Set (BSS) Color in a physical layer (PHY) header of the TB PPDU to a BSS color of the wireless AP.

20. The method of claim 12, wherein before the TB PPDU is transmitted to the wireless AP, the wireless AP requests the wireless device to perform a clear channel assessment (CCA).
